(19) United States
(12) Patent Application Publication
(10) Pub. No.: US 2014/0375296 A1
(43) Pub. Date: Dec. 25, 2014

(54) POWER TRANSFORMING DEVICE WITH A POWER-SAVING CIRCUIT LOOP

(71) Applicant: Cyber Power Systems Inc., Taipei (TW)

(72) Inventor: Jian Wang, Taipei (TW)

(21) Appl. No.: 13/923,698

(22) Filed: Jun. 21, 2013

(51) Int. Cl. H02M 1/08

(52) U.S. Cl. CPC H02M 1/08
USPC 323/318

(57) ABSTRACT

A power transforming device with a power-saving circuit loop is connected between a voltage source and an electric/electronic appliance, and has a micro-controller unit (MCU), a mode-switching circuit, a conversion circuit, and an output circuit. The mode-switching circuit has a switching element. The conversion circuit has an isolating element and a winding. The isolating element and one end of the winding are connected to the switching element. The output circuit has a switching element having one contact connected with the winding and another contact connected with the switching element of the mode-switching circuit. The MCU controls the isolating element and the switching elements to boost or buck down an input voltage according to the value of the input voltage, and directly outputs the input voltage without additionally consuming energy when voltage transforming operation is not required.

### BACKGROUND OF THE INVENTION

1. Field of the Invention

The present invention relates to a power transforming device, and more particularly to a power transforming device with a power-saving circuit loop performing electromagnetic conversion only when voltage transformation is required.

2. Description of the Related Art

When buying home electric/electronic appliances, most people are inclined to choose those with Energy Star Certification. Energy Star is an international standard established by U.S.A for energy efficient consumer products. According to surveys of consumer shopping habits, more than seventy percent of consumers would purchase products with Energy Start Certification, and a majority of consumers think that such type of products are more durable. Once an electric/electronic product has any recognized energy-saving sticker thereon, it represents that the product possesses higher energy efficiency, and can save more energy and money for operation.

With reference to FIG. 9, a conventional power transforming device has an auto-transformer 60, a first switch 61, a second switch 62, and an output switch 63.

The auto-transformer 60 has a winding. A first end of the winding is connected to a live line N of a power source, and a second end of the winding is connected between the first switch 61 and the second switch 62. The winding has a first tap 601 thereon. The second switch is further connected to the output switch 63.

The first switch 61 has a common terminal (COM), a normally closed terminal (NC), and a normally open terminal (NO), wherein the common terminal is connected to the live line of the power source, and the normally closed terminal (NC) and the normally open terminal (NO) are respectively connected to the second end and the first tap 601 of the winding.

The second switch 62 has a common terminal (COM), a normally closed terminal (NC), and a normally open terminal (NO), wherein the normally closed terminal (NC) and the normally open terminal (NO) are respectively connected to the second end and the first tap 601 of the winding.

The output switch 63 has a common terminal (COM), a normally closed terminal (NC), and a normally open terminal (NO), wherein the common terminal (COM) constitutes a power output terminal, and the normally open terminal is connected to the common terminal (COM) of the second switch 62.

As shown in FIG. 9, the first switch 61 and the output switch 63 are controlled in a manner that the common terminal (COM) of the first switch 61 is connected with the normally closed terminal (NC) thereof, and the common terminal of the output switch 63 is connected with the normally closed terminal (NC) thereof, and the conventional power transforming device is operated under a turn-off mode.

In comparison with the turn-off mode, when the auto-transformer 60 is operated under a voltage boosting mode, the common terminal (COM) of the first switch 61 is connected with the normally open terminal (NO) thereof so that a primary winding is formed by a portion of the winding from the first tap 601 to the first end. The common terminal (COM) of the second switch 62 is connected with the normally closed terminal (NC) thereof so that a secondary winding is formed by the entire portion of the winding from the second end to the first end. The common terminal (COM) of the output switch 63 is connected with the normally open terminal (NO) thereof to output voltage. As the primary winding is a part of the secondary winding and the secondary winding has more turns than the primary winding, the output voltage is boosted.

When the auto-transformer 60 is operated under a voltage bucking mode, the common terminal (COM) of the first switch 61 is connected with the normally closed (NC) terminal thereof so that a primary winding is formed by the entire portion of the winding from the second end to the first end. The common terminal (COM) of the second switch 62 is connected with the normally open terminal (NO) thereof so that a secondary winding is formed by a portion of the winding from the first tap 601 to the first end. The common terminal (COM) of the output switch 63 is connected with the normally open terminal (NO) thereof to output voltage. As the secondary winding is a part of the primary winding and the primary winding has more turns than the secondary winding, the output voltage is bucked down.

With reference to FIGS. 10 and 11, another conventional power transforming device is substantially the same as the foregoing conventional power transforming device except that the winding further has a second tap 602 located between the first tap 601 and the first end of the winding. The normally closed terminal (NC) and the normally open terminal (NO) of the first switch 61 are respectively connected to the second end and the second tap 602 of the winding. The normally closed terminal (NC) and the normally open terminal (NO) of the second switch 62 are respectively connected to the second end and the first tap 601 of the winding.

Similarly, the conventional power transforming device is operated under a turn-off mode as shown in FIG. 10 with the common terminal (COM) of the output switch 63 connected with the normally closed terminal (NC) to turn off the power transforming device, and is operated under a direct-output mode as shown in FIG. 11 with the common terminal (COM) of the output switch 63 connected with the normally open terminal (NO) thereof, the common terminal of the second switch 62 connected with the normally closed terminal thereof, and the common terminal of the first switch 61 connected with the normally closed terminal. During the direct-output mode, there is no voltage bucking and boosting operation as the primary and secondary windings have the same turns.

When the auto-transformer 60 is operated under a voltage boosting mode, similarly, the common terminal of the first switch 61 is connected to the normally open terminal (NO) thereof so that a primary winding is formed by a portion of the winding from the second tap 602 to the first end. The common terminal (COM) of the second switch 62 is connected to the normally closed terminal (NC) or the normally open terminal (NO) thereof so that a secondary winding is formed by a portion of the winding from the second end or the first tap 601 to the first end. The common terminal (COM) of the output switch 63 is connected with the normally open terminal (NO). As the secondary winding has more turns than the primary winding, the output voltage is boosted.

When the auto-transformer 60 is operated under a voltage bucking mode, the common terminal of the first switch 61 is connected to the normally closed terminal (NC) thereof so that a primary winding is formed by the entire portion of the winding from the second end to the first end. The common terminal (COM) of the second switch 62 is connected to the normally open terminal (NO) thereof so that a secondary winding is formed by a portion of the winding from the first tap 601 to the first end. The common terminal (COM) of the output switch 63 is connected with the normally open terminal (NO). As the primary winding has more turns than the secondary winding, the output voltage is bucked down.

The foregoing conventional power transforming devices can all be connected to electric/electronic appliances, and are extensively applied to protect the boosting/bucking loop or the output loop. However, one end of such type of auto-transformer 60 needs to be constantly connected to the loops. Extra electromagnetic energy and power consumption are generated by the auto-transformer 60 whenever the auto-transformer 60 performs the voltage boosting/bucking operation or directly outputs the input voltage.

### SUMMARY OF THE INVENTION

An objective of the present invention is to provide a power transforming device with a power-saving circuit loop connected between a voltage source and an electric/electronic appliance, and boosting or bucking down an input voltage according to the value of the input voltage, and directly outputting the input voltage without additionally consuming energy when voltage transforming operation is not required.

To achieve the foregoing objective, the power transforming device with a power-saving circuit loop has a mode-switching circuit, a conversion circuit, an output circuit, and a micro-controller unit (MCU).

The mode-switching circuit has a voltage input terminal and a switching element. The switching element has a first contact and a second contact.

The conversion circuit has an auto-transformer and an isolating element.

The auto-transformer has at least one tap, one of which is connected to the second contact of the switching element.

The isolating element has a common terminal, a normally closed terminal, and a normally open terminal. The common terminal is connected to the first contact of the switching element. The normally open terminal is connected to one end of the auto-transformer.

The output circuit has a switching element and a voltage output terminal.

The switching element has a third contact and a fourth contact. The third contact is connected with one of the at least one tap. The fourth contact is connected with the common terminal of the isolating element.

The MCU is connected to the switching element of the mode-switching circuit, the isolating element of the conversion circuit, the switching element of the output circuit, and the voltage input terminal of the mode-switching circuit, and has at least one voltage threshold.

The MCU first compares an input voltage with the voltage threshold, and controls the isolating element and the switching elements of the mode-switching circuit and the output circuit to switch their contacts for the input voltage to pass through the auto-transformer to perform a voltage boosting or bucking operation, so that an output voltage can be stably outputted and comply with the voltage threshold. When power transforming operation is not required, the isolating element can be used to isolate the auto-transformer from a power transforming loop, thereby reducing energy consumption and enhancing power utilization efficiency.

Other objectives, advantages and novel features of the invention will become more apparent from the following detailed description when taken in conjunction with the accompanying drawings.

### BRIEF DESCRIPTION OF THE DRAWINGS

FIG. 1 is a first circuit diagram of a first embodiment of a power transforming device with a power-saving circuit loop in accordance with the present invention operated under a turn-off mode;

FIG. 2 is a second circuit diagram of the power transforming device in FIG. 1 operated under an energy-saving mode;

FIG. 3 is a third circuit diagram of the power transforming device in FIG. 1 operated under a bucking mode;

FIG. 4 is a fourth circuit diagram of the power transforming device in FIG. 1 operated under a boosting mode;

FIG. 5 is a first circuit diagram of a second embodiment of a power transforming device with a power-saving circuit loop in accordance with the present invention operated under an energy-saving mode;

FIG. 6 is a second circuit diagram of the power transforming device in FIG. 5 operated under a bucking mode;

FIG. 7 is a third circuit diagram of the power transforming device in FIG. 5 operated under a boosting mode;

FIG. 8 is a fourth circuit diagram of a power transforming device in FIG. 5 operated under another boosting mode;

FIG. 9 is a circuit diagram of a conventional power transforming device operated under a turn-off mode;

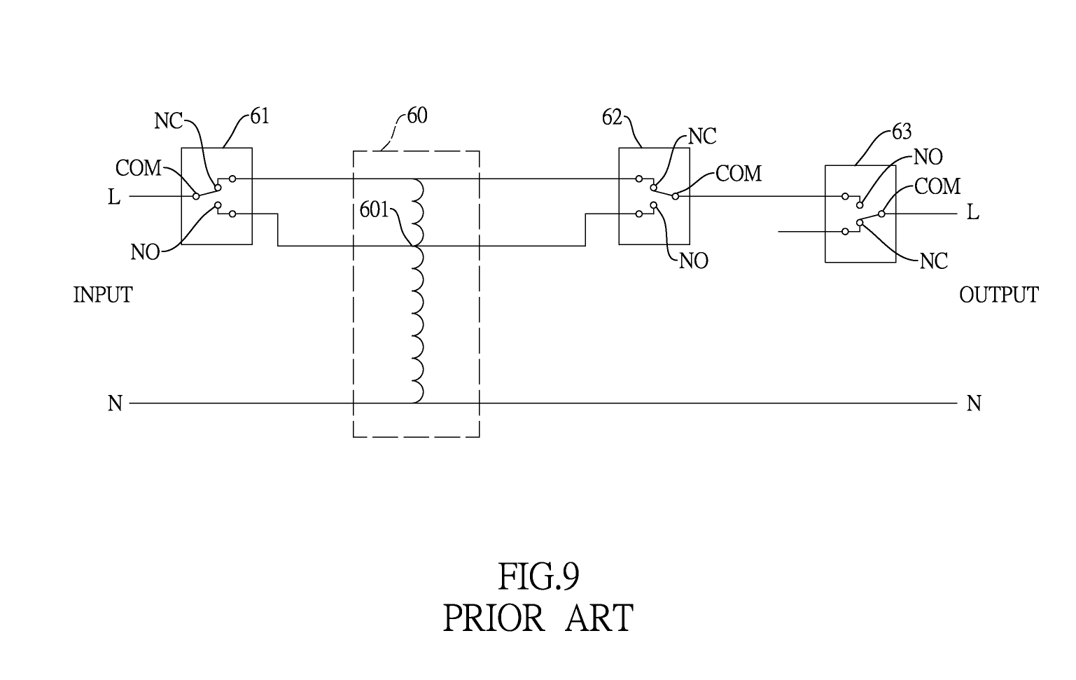

FIG. 10 is a circuit diagram of another conventional power transforming device with two taps during a turn-off mode; and

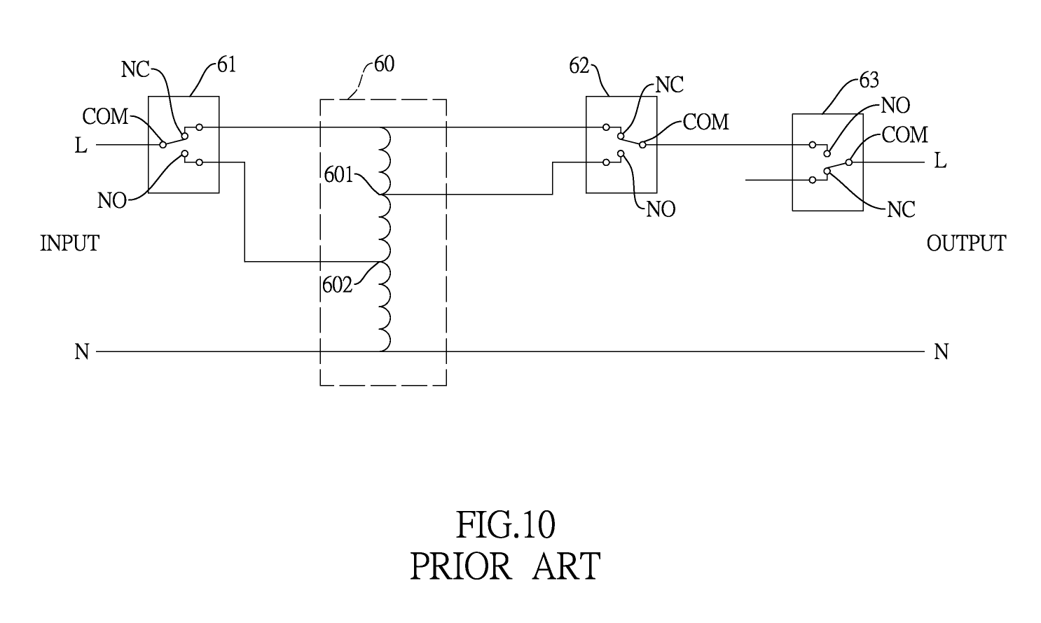

FIG. 11 is another circuit diagram of the conventional power transforming device in FIG. 10 during a direct-output mode.

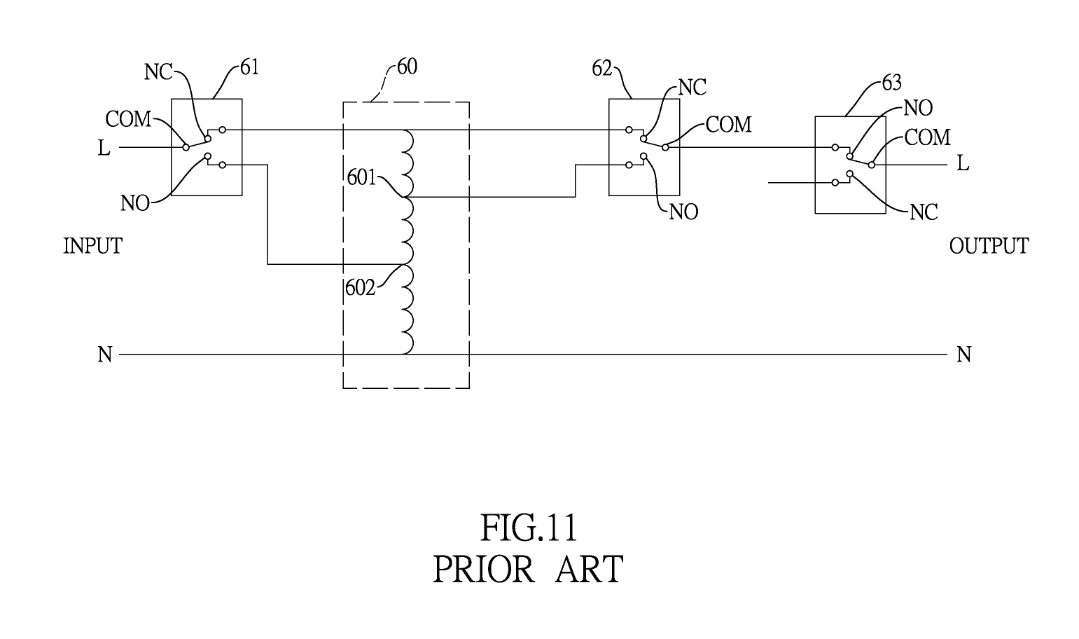

### DETAILED DESCRIPTION OF THE INVENTION

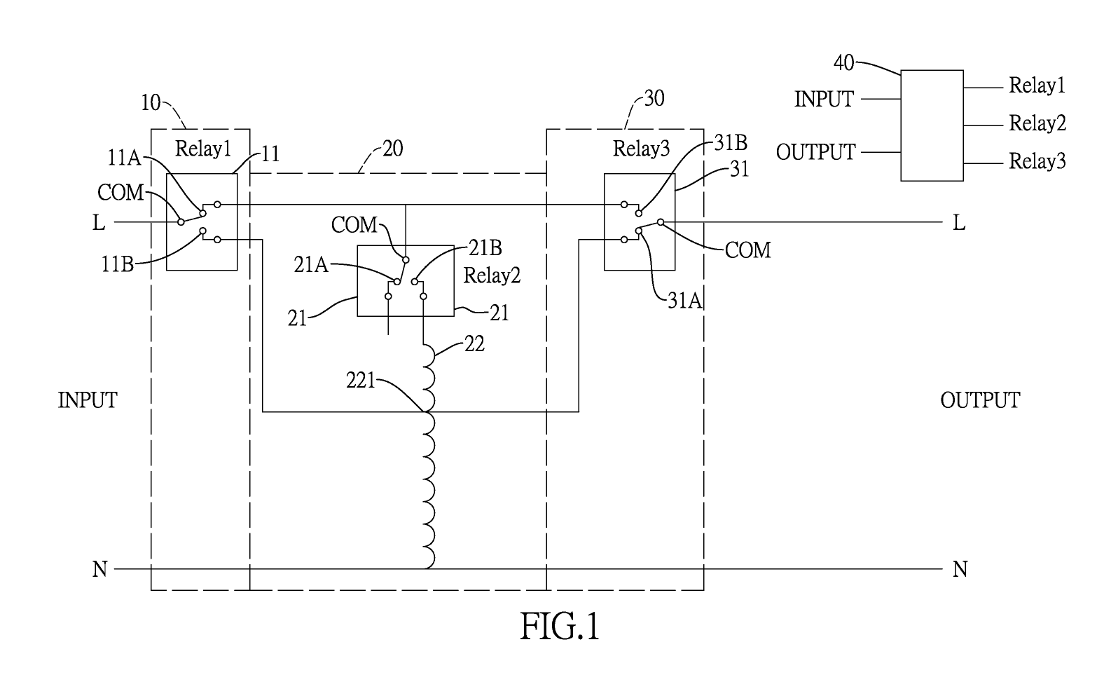

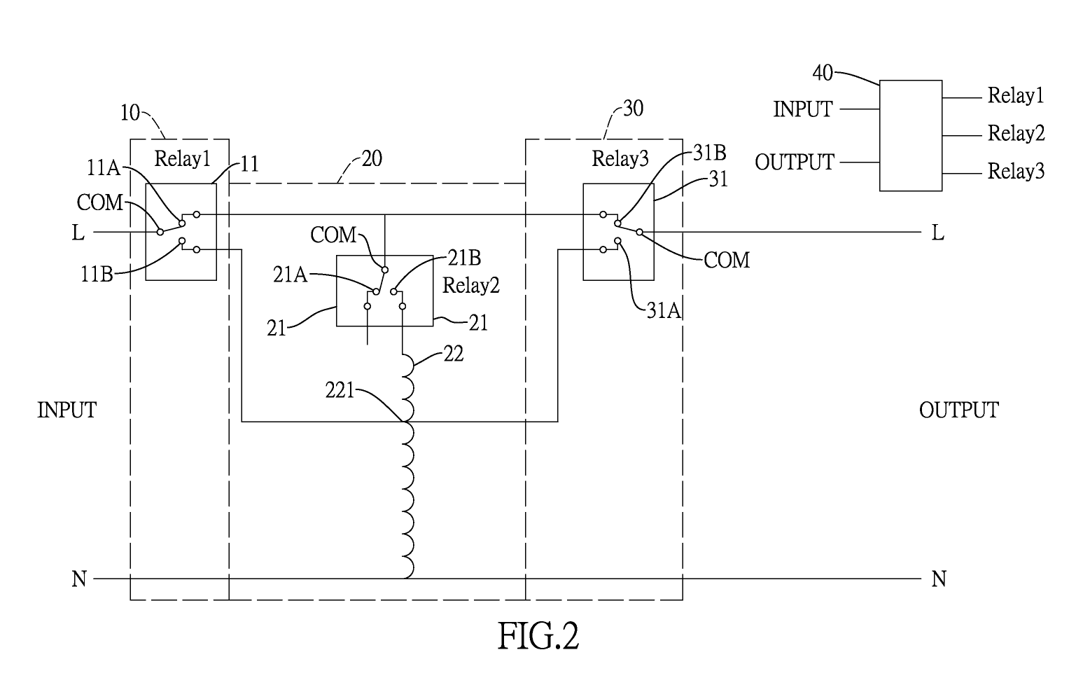

With reference to FIGS. 1 and 2, a power transforming device with a power-saving circuit loop in accordance with the present invention is connected between a voltage source and an electric/electronic appliance, and has a mode-switching circuit 10, a conversion circuit 20, an output circuit 30, and a micro-controller unit (MCU) 40.

The mode-switching circuit 10 has a voltage input terminal, that is, a live/neutral line (L/N) of a power source, and a switching element 11. The switching element 11 has a first contact 11A and a second contact 11B. In the present embodiment, the switching element 11 is a relay (Relay1). The foregoing voltage input terminal is a common terminal (COM) of the Relay1.

The conversion circuit 20 has an isolating element 21 and an auto-transformer 22. The auto-transformer 22 has a winding. The winding has a first end connected to the neutral line of the voltage source, a second end, and a first tap 221 between the first end and the second end. The isolating element 21 has a common terminal (COM), a normally closed terminal 21A, and a normally open terminal 21B. The normally open terminal 21B is connected to the second end of the winding. The first tap 221 is connected to the second contact 11B of the switching element 11 to constitute a primary winding. In the present embodiment, the isolating element 21 is another relay (Relay2). The common terminal (COM) of the Relay2 is connected with the normally closed terminal 21A thereof and an open circuit exists between the normally closed terminal 21A and the auto-transformer 22 so as to isolate the auto-transformer 22.

The output circuit 30 has a switching element 31 and a voltage output terminal, that is, the live/neutral line (L/N) of the power source. The switching element 31 has a third contact 31A and a fourth contact 31B. The third contact 31A is connected with the first tap 221 of the winding to constitute a secondary winding. The fourth contact 31B is connected to the first contact 11A of the switching element 11 and the common terminal (COM) of the isolating element 21 to constitute a power transforming loop. In the present embodiment, the switching element 31 is a relay (Relay3) and the voltage output terminal is a common terminal (COM) of the Relay3.

The MCU 40 is connected to the switching element 11 of the mode-switching circuit 10, the isolating element 21 of the conversion circuit 20, an excitation coil of the switching element 31 of the output circuit 30, and the voltage input terminal of the mode-switching circuit 10, and has a voltage threshold. The MCU 40 first compares an input voltage value with the voltage threshold. If the input voltage value differs from the voltage threshold, the MCU 40 controls the Relay1, Relay2 and Relay3 to vary a ratio of the turns of the secondary winding over the turns of the primary winding, thereby boosting or bucking down the input voltage to output a voltage meeting a desired voltage threshold and stably outputting the voltage. Otherwise, the MCU 40 controls the Relay1, Relay2 and Relay3 to operate the power transforming device in an energy-saving mode.

When there is no voltage outputted from the voltage output terminal or the power transforming device is operated under a turn-off mode as shown in FIG. 1, the MCU 40 controls the common terminal (COM) of the Relay1 to be connected with the first contact 11A thereof, the common terminal of the isolating element 21 to be connected with the contact 21A, and the common terminal (COM) of the Relay3 to be connected with the third contact 31A.

When input voltage is directly outputted to the output terminal or the power transforming device is operated under an energy-saving mode as shown in FIG. 2, the MCU 40 controls the common terminal (COM) of the Relay1 to be connected with the first contact 11A thereof, the common terminal of the isolating element 21 to be connected with the contact 21A, and the common terminal (COM) of the Relay3 to be connected with the fourth contact 31B. An open circuit exists between the normally closed terminal 21A of the isolating element 21 and the auto-transformer 22 so as to isolate the auto-transformer 22 from the power transforming loop. The states of the Relay1 and Relay3 allow an input voltage equal to the voltage threshold to be directly outputted to the voltage output terminal without going through the auto-transformer 22, and the power transforming device therefore saves more power because no power is consumed by the auto-transformer 22.

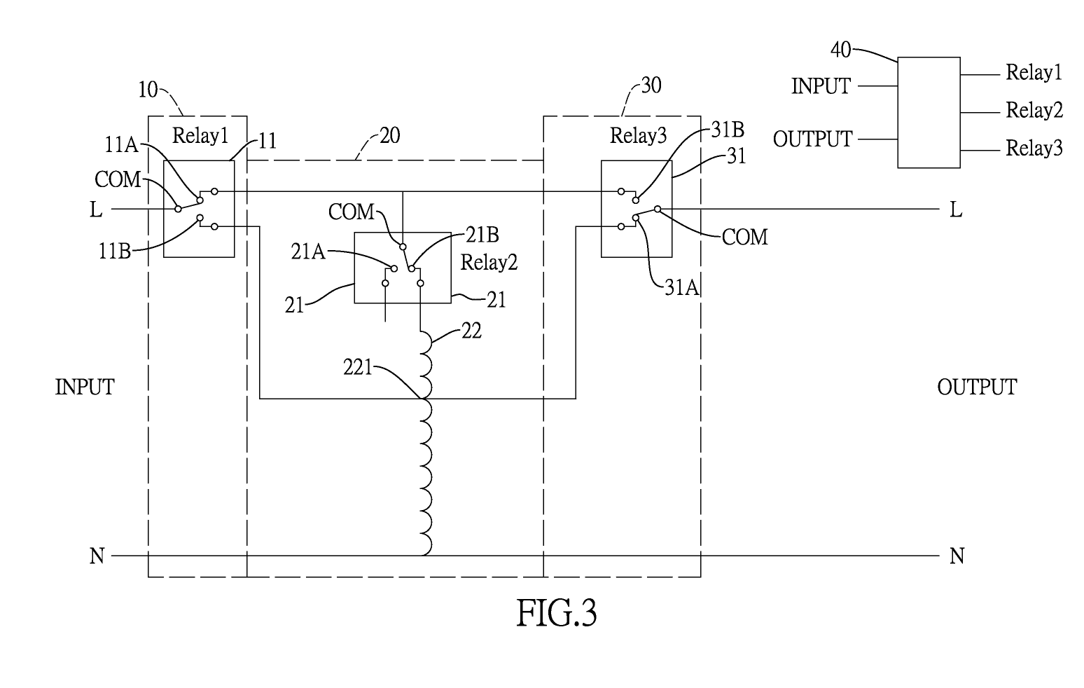

With reference to FIG. 3, when the power transforming device is operated under a bucking mode, the MCU 40 controls the Relay1, Relay2 and Relay3 in a manner that the common terminal (COM) of the Relay1 is connected with the first contact 11A thereof, the common terminal (COM) of the Relay2 is connected with the normally open terminal 21B thereof, and the common terminal of the Relay3 is connected with the third contact 31A, so that a primary winding is formed by the entire portion of the winding and a secondary winding is formed by a portion of the winding from the first tap 221 to the first end. As the primary winding has more turns than the secondary winding, an input voltage higher than the voltage threshold is bucked down to the voltage threshold and is outputted to the voltage output terminal.

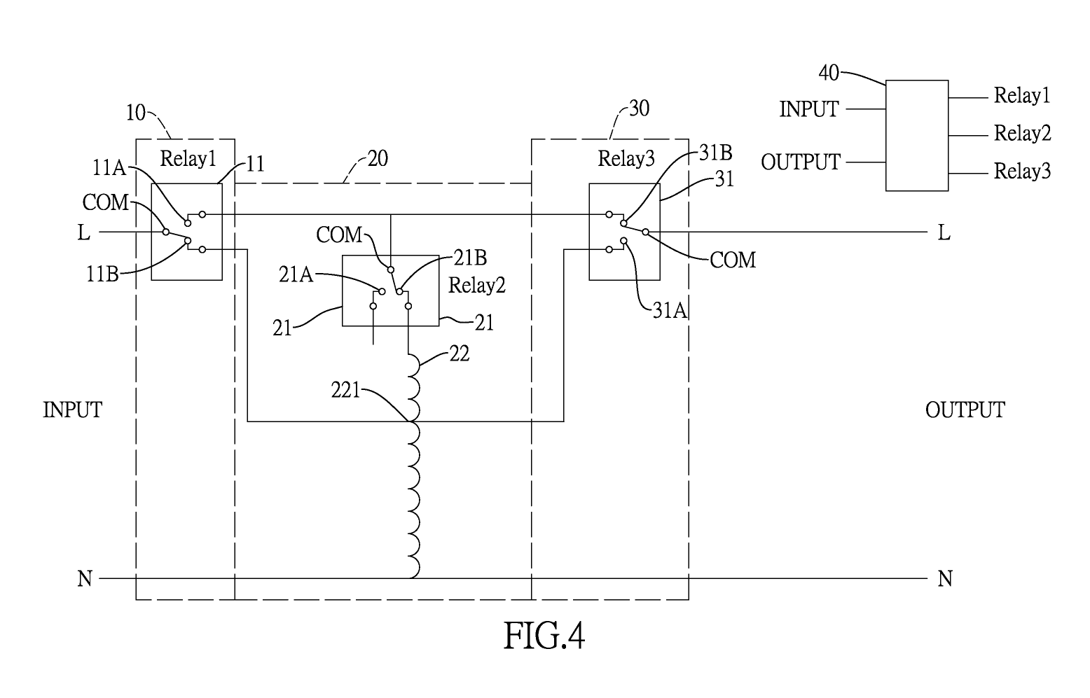

With reference to FIG. 4, when the power transforming device is operated under a boosting mode, the MCU 40 controls the Relay1, Relay2 and Relay3 in a manner that the common terminal (COM) of the Relay1 is connected with the second contact 11B thereof, the common terminal (COM) of the Relay2 is connected with the normally open terminal 21B thereof, and the common terminal of the Relay3 is connected with the fourth contact 31B, so that a primary winding is formed by a portion of the winding from the first tap 221 to the first end and a secondary winding is formed by the entire portion of the winding. As the primary winding has fewer turns than the secondary winding, an input voltage lower than the voltage threshold is boosted to the voltage threshold and is outputted to the voltage output terminal.

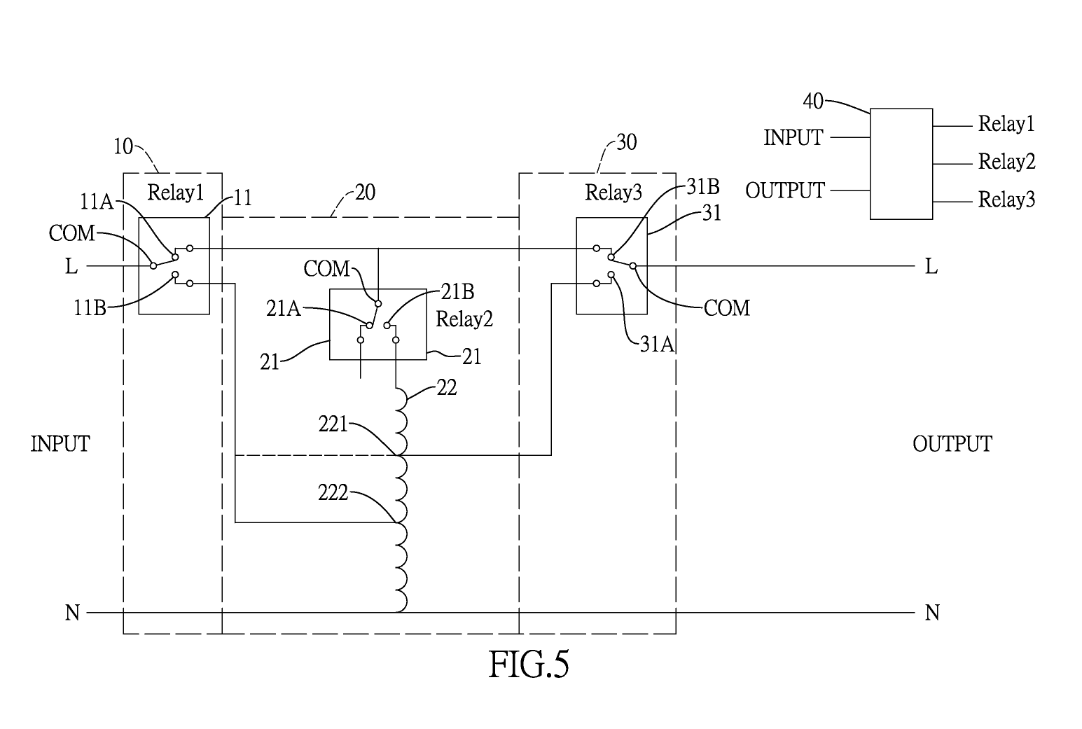

With reference to FIG. 5, a second embodiment of a power transforming device with a power-saving circuit loop in accordance with the present invention is substantially the same as the foregoing embodiment except that the winding further has a second tap 222 located between the first tap 221 and the first end of the winding. The power transforming device is operated under an energy-saving mode, and the MCU 40 controls Relay1, Relay2 and Relay 3 in a manner that the common terminal (COM) of the Relay1 is connected with the first contact 11A thereof, the common terminal (COM) of the Relay2 is connected with the normally closed terminal 21A thereof, and the common terminal (COM) of the Relay3 is connected with the fourth contact 31B. An open circuit exists between the normally closed terminal 21A of the isolating element 21 and the auto-transformer 22 so as to isolate the auto-transformer 22 from the power transforming loop. The states of the Relay1 and Relay3 allow an input voltage equal to the voltage threshold to be directly outputted to the voltage output terminal without going through the auto-transformer 22, and the power transforming device therefore saves more power because no power is consumed by the auto-transformer 22.

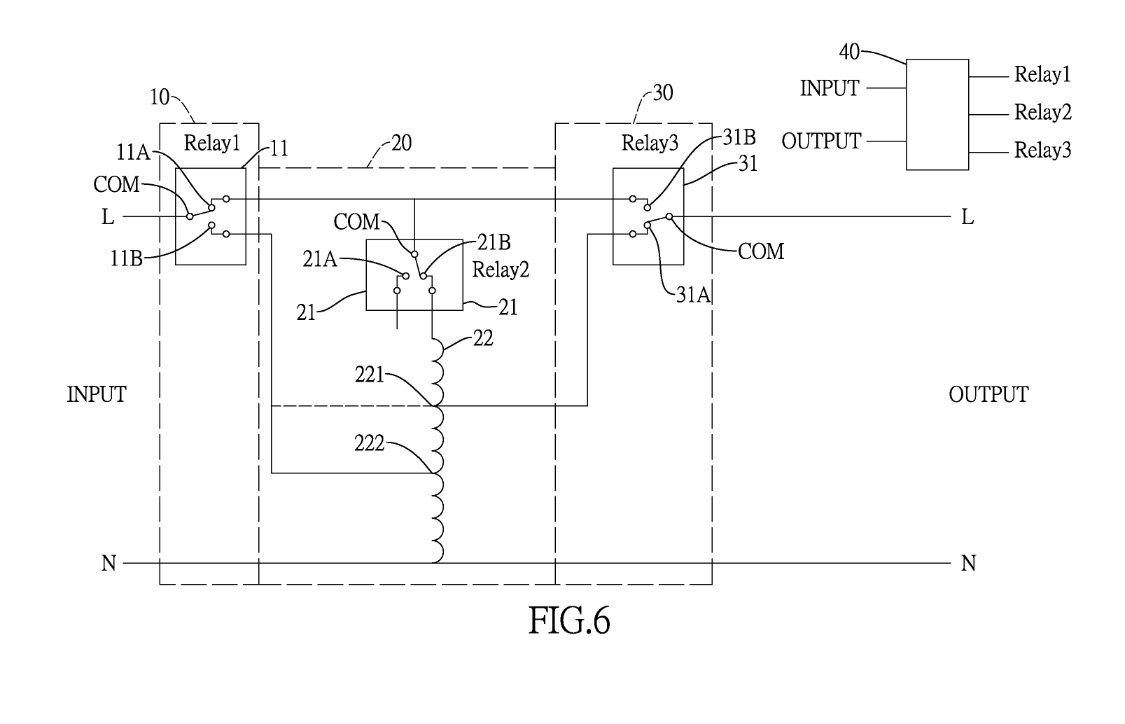

With reference to FIG. 6, when the power transforming device in FIG. 5 is operated under a bucking mode, the MCU 40 controls the Relay1, Relay2 and Relay3 in a manner that the common terminal (COM) of the Relay1 is connected with the first contact 11A thereof, the common terminal (COM) of the Relay2 is connected with the normally open terminal 21B thereof, and the common terminal of the Relay3 is connected with the third contact 31A, so that a primary winding is formed by the entire portion of the winding and a secondary winding is formed by a portion of the winding from the first tap 221 to the first end. As the primary winding has more turns than the secondary winding, an input voltage higher than the voltage threshold is bucked down to the voltage threshold and is outputted to the voltage output terminal.

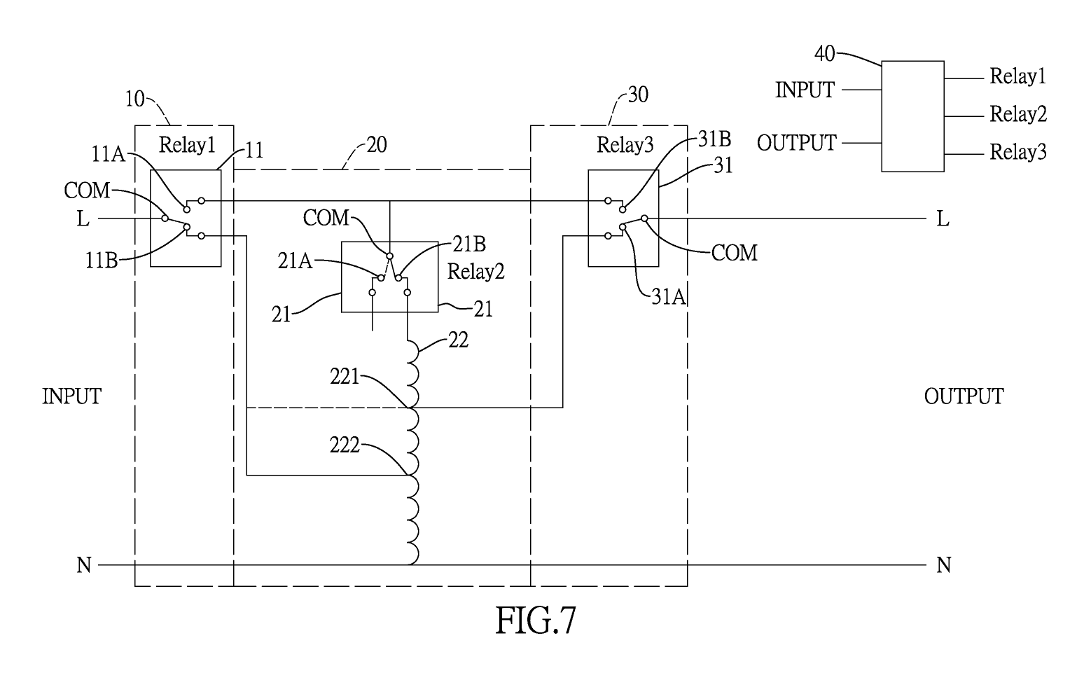

With reference to FIG. 7, when the power transforming device in FIG. 5 is operated under a boosting mode of, the MCU 40 controls the Relay1, Relay2 and Relay3 in a manner that the common terminal (COM) of the Relay1 is connected with the second contact 11B thereof, the common terminal (COM) of the Relay2 is selectively connected with the normally closed terminal 21A or the normally open terminal 21B thereof, and the common terminal of the Relay3 is connected with the third contact 31A, so that a primary winding is formed by a portion of the winding from the second tap 222 to the first end and a secondary winding is formed by a portion of the winding from the first tap 221 to the first end. As the primary winding has fewer turns than the secondary winding, an input voltage lower than the voltage threshold is boosted to the voltage threshold and is outputted to the voltage output terminal.

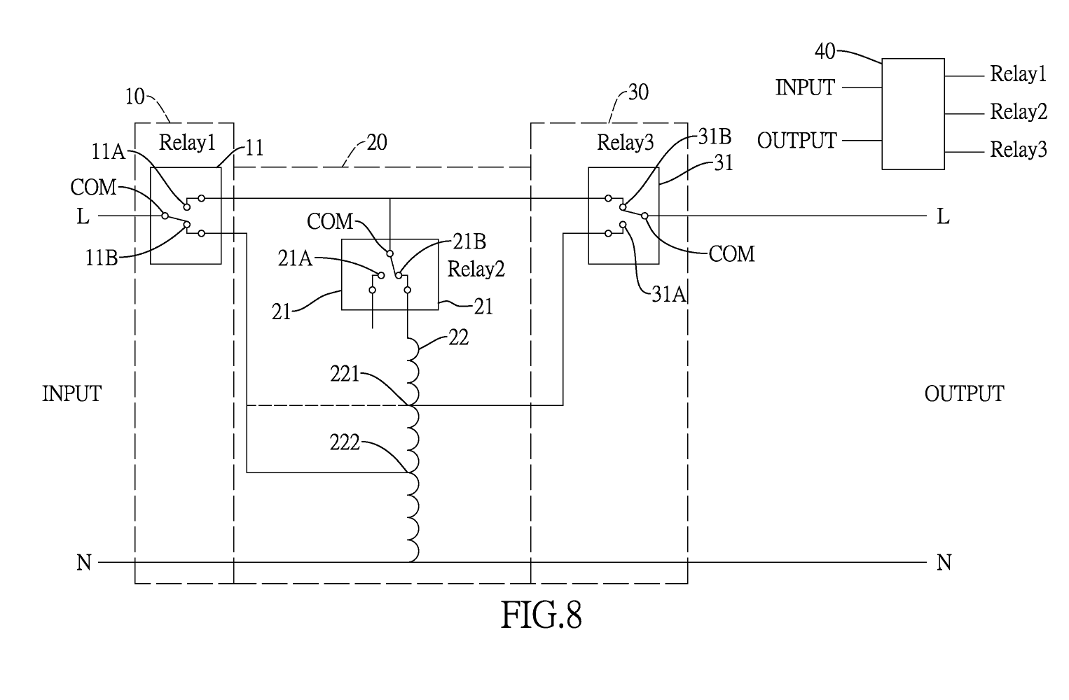

With reference to FIG. 8, when the power transforming device in FIG. 5 is operated under another boosting mode, the MCU 40 controls the Relay1, Relay2 and Relay3 in a manner that the common terminal (COM) of the Relay1 is connected with the second contact 11B thereof, the common terminal (COM) of the Relay2 is connected with the normally open terminal 21B thereof, and the common terminal of the Relay3 is connected with the fourth contact 31B, so that a primary winding is formed by a portion of the winding from the second tap 222 to the first end and a secondary winding is formed by the entire portion of the winding. As the primary winding has fewer turns than the secondary winding, an input voltage lower than the voltage threshold is boosted to the voltage threshold and is outputted to the voltage output terminal.

According to the foregoing embodiments, the MCU 40 first compares an input voltage with a voltage threshold built in the MCU 40, and controls the three relays (Relay1, Relay2 and Relay3) for the input voltage to pass through the first tap 221, the second tap 222 and the second end of the winding of the auto-transformer 22 to enter the bucking mode and the boosting mode, thereby outputting a voltage in compliance with desired voltage thresholds. When the input voltage is equal to the voltage threshold and the bucking mode and the boosting is not applied, the isolating element 21 is used to isolate the auto-transformer 22 from the power transforming loop to eliminate the energy consumed by the auto-transformer 22 and enhance the power utilization efficiency.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A power transforming device with a power-saving circuit loop, comprising:
a mode-switching circuit having a voltage input terminal and a switching element, wherein the switching element has a first contact and a second contact;
a conversion circuit having:
an auto-transformer having at least one tap, one of which is connected to the second contact of the switching element; and
an isolating element having:
a common terminal connected to the first contact of the switching element;
a normally closed terminal; and
a normally open terminal connected to one end of the auto-transformer;
an output circuit having:
a switching element having:
a third contact connected with one of the at least one tap; and
a fourth contact connected with the common terminal of the isolating element; and
a voltage output terminal; and
a micro-controller unit (MCU) connected to the switching element of the mode-switching circuit, the isolating element of the conversion circuit, the switching element of the output circuit, and the voltage input terminal of the mode-switching circuit, and having at least one voltage threshold.

2. The power transforming device as claimed in claim 1, wherein
the auto-transformer comprises:
a first tap connected to the second contact of the switching element; and
a second tap located between the first tap and the voltage input terminal of the mode-switching circuit, and connected to the second contact of the switching element of the mode-switching circuit;
the third contact of the switching element of the output circuit is connected to the first tap of the auto-transformer; and
the MCU further has another voltage threshold.

3. The power transforming device as claimed in claim 1, wherein the switching element of the mode-switching circuit is a relay having a common terminal being the voltage input terminal of the mode-switching circuit.

4. The power transforming device as claimed in claim 2, wherein the switching element of the mode-switching circuit is a relay having a common terminal being the voltage input terminal of the mode-switching circuit.

5. The power transforming device as claimed in claim 3, wherein the isolating element of the conversion circuit is a relay.

6. The power transforming device as claimed in claim 4, wherein the isolating element of the conversion circuit is a relay.

7. The power transforming device as claimed in claim 5, wherein the switching element of the output circuit is a relay having a common terminal being the voltage output terminal of the output circuit.

8. The power transforming device as claimed in claim 6, wherein the switching element of the output circuit is a relay having a common terminal being the voltage output terminal of the output circuit.
